(19) United States
(12) Patent Application Publication
(10) Pub. No.: US 2007/0146200 A1
(43) Pub. Date: Jun. 28, 2007

(54) Method and apparatus for providing advertising and real time content to a mobile device based upon location

(75) Inventors: John L. Norin, Redondo Beach, CA (US); Sean S. Lee, Rockville, MD (US)

Correspondence Address: THE DIRECTV GROUP INC, PATENT DOCKET ADMINISTRATION RE/R11/A109, P O BOX 956, EL SEGUNDO, CA, 90245-0956, US

(73) Assignee: The DirecTV Group, Inc.

(21) Appl. No.: 11/595,416

(22) Filed: Nov. 10, 2006

Related U.S. Application Data
(63) Continuation-in-part of application No. 11/319,673, filed on Dec. 28, 2005.

(51) Int. Cl. G01S 5/14; H04Q 7/20

(52) U.S. Cl. 342/357.09; 455/456.3

(57) ABSTRACT

A mobile wireless system (10) for displaying real-time content or advertising based on location is set forth. Communication signals (200) are broadcast from various communication devices (18), (33), (34A) that include a marker (204). Various location-specific content signals (230) are broadcast that have location information (232) therein. Advertising data (234) or other real-time content may be included with the location-specific signals. The advertising data (234) or real-time content is displayed in place of other real-time or broadcast signals when the location of the receiving device is within the area defined by the location information broadcast with the advertising a real-time content signal.

### RELATED APPLICATION

This application is a continuation-in-part of U.S. patent application Ser. No. 11/319673, filed on Dec. 28, 2005. The disclosure of the above application is incorporated herein by reference.

### TECHNICAL FIELD

The present invention relates generally to a mobile receiving device, and more specifically, to a method for controlling advertising or other content displayed information according to the location of the mobile receiving device based upon boundaries conveyed to the mobile device.

### BACKGROUND

Satellite television has become increasingly popular due to its wide variety of programming. Entertainment in automobiles such as DVD players has also become increasingly popular. It would be desirable to provide a satellite television system for a vehicle so that the wide variety of programming may be enjoyed by the rear passengers.

Advertising in the television medium is commonly done on a national level. Advertising is broadcast nationwide for most time slots. Local television stations are allotted some time slots for advertising that is directed to a local viewing market. Stores and various other types of commercial ventures buy air time from broadcasters for the placement of advertising. Advertising is typically broadcast as part of the signal and is transmitted to all the viewers in the local market. Thus, the advertising is generated to a wide audience and is priced accordingly. Some businesses are local even within a particular market. Advertising over the entire market may be cost prohibitive. Advertisers would like the option to advertise very locally within a local market.

It would therefore be desirable to provide a system that allows a mobile satellite system to insert targeted advertising or other real-time content to a narrow market within a local market.

### SUMMARY OF THE INVENTION

The present invention provides a method of operating a mobile device that takes into consideration the location of the mobile receiving device when the content such as advertising is played back.

One feature of the present invention includes a method of operating a mobile broadcasting system that includes determining a location of a mobile receiving device, broadcasting a communication signal having a marker therein, broadcasting location-specific content to a mobile receiving device, displaying the satellite signal on a mobile receiver until the marker, and displaying the location specific content in response to the marker and the location.

Another feature of the invention is a method of operating a mobile receiver that includes determining a location of a mobile satellite receiver, receiving a satellite signal having a marker therein, receiving location-specific content and location information in a mobile satellite receiver, displaying the satellite signal on a mobile satellite receiver until the marker, comparing the location and an area defined by the location information, and displaying the location specific content in response to the marker and when the location is within the area.

Yet another feature of the invention includes a system that includes a high altitude communication device and a network operations center communicating uplinking signals to the satellite. The high altitude communication device broadcasts a satellite signal corresponding to the uplink signal to a receiver. A second communication device generates location-specific content. A location module generates a location signal. A receiver coupled to the location module. The receiver receives the satellite signal having a marker therein. The receiver receives the location specific content to a mobile receiving device, displaying the satellite signal on a mobile receiver until the marker, displaying the location specific content in response to the marker and the location signal.

Yet another feature of the invention includes a receiver having a location module generating a location signal and a controller receiving a satellite signal and determining the presence of a marker, said controller receiving location-specific content, said controller controlling a display by displaying the satellite signal until the marker then displaying the location specific content in response to the marker and the location signal.

One advantage of the system is that the advertising information may be specifically targeted for a particular area. For example, if a certain store is having a limited time sale that real time information may be conveyed.

Other advantages and features of the present invention will become apparent when viewed in light of the detailed description of the preferred embodiment when taken in conjunction with the attached drawings and appended claims.

### BRIEF DESCRIPTION OF THE DRAWINGS

FIG. 1 is a system level view of a satellite broadcasting system according to the present invention.

FIG. 2 is a block diagrammatic view of a vehicle having a receiving system according to the present invention.

FIG. 3a is a signal representation of a broadcast satellite signal.

FIG. 3b is a signal representation of an advertising signal.

FIG. 4 is a flow chart illustrating one method for operating the present invention.

### DETAILED DESCRIPTION

In the following figures the same reference numerals will be used for the same views. The following figures are described with respect to a mobile satellite television system. However, those skilled in the art will recognize the teachings of the present invention may be applied to various types of mobile reception including land-based type systems. The system is used for transmitting location specific data that may also include real-time data.

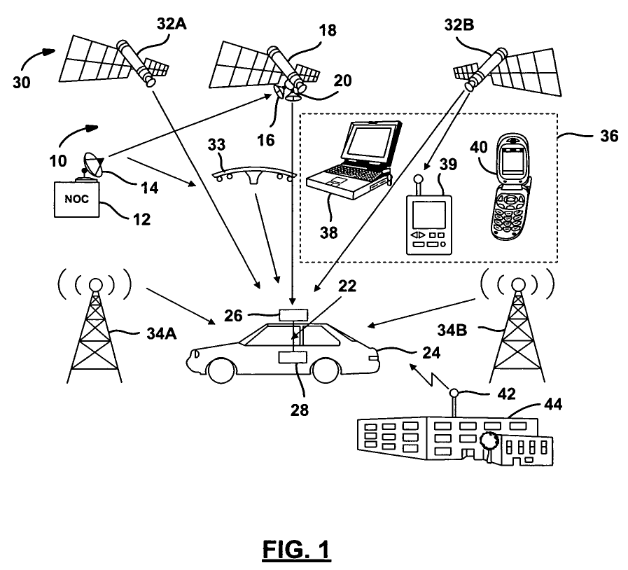

Referring now to FIG. 1, a satellite television broadcasting system 10 is illustrated. The satellite television broadcasting system 10 includes a network operations center 12 that generates wireless communication signals through a transmitting antenna 14 which are received by a receiving antenna 16 of a high altitude device such as a spaced-based satellite 18. The wireless communication signals, for example, may be digital, digital video, data or digital audio. As will be described below, the wireless communication signals may be entertainment content or boundary point data for areas of interest such as designated marketing areas. Areas of interest may also include traffic, weather, hazardous material warning areas, advertising marketing area near a particular store or region or other types of areas. The communication signals from the satellite may also include location-specific signals with location information therein. The location information may correspond to a geographic area in which the location specific information is valid or suitable for. A transmitting antenna 20 generates signals directed to various receiving systems including stationary systems such as those in the home as well as mobile receiving systems 22. The wireless signals may have various types of information associated with them including location information. The wireless signals may also have various video and audio information associated therewith. As illustrated, the mobile receiving system 22 is disposed within an automotive vehicle 24. A receiving antenna 26 receives the wireless signals from the satellite 18 and processes the signals in a mobile receiving unit 28. The mobile receiving unit 28 will be further described below.

The system 10 may also receive location signals from a GPS system 30 that includes a first satellite 32A and a second satellite 32B. Although only two satellites are shown, a typical GPS system includes several satellites, several of which may be in view at any particular time. Triangulation techniques may be used to determine the elevation, latitude and longitude of the system. A locating system may also include cellular towers 34A and 34B that may be used by the mobile receiving system 22 to determine a location. The towers may also be cellular phone, radio or TV towers generating location signals. Cellular phones typically include a GPS locating system. As the vehicle 24 moves, the exact coordinates in latitude and longitude may be used to determine the proper area of interest such as a designated marketing area which will control the mobile device's choices for local television and such broadcasted data.

The system may also receive boundary information such as boundary points of designated marketing area polygons from the terrestrial-based system such as the cellular towers 34A and 34B. In addition, the satellites may also be replaced with another high altitude device such as a stratospheric platform 33 for transmitting the designated marketing areas to the mobile device, transmitting communication signals and transmitting location-specific signals. Stratospheric platforms 33 are manned or unmanned airplanes, airships, or the like that fly above commercial airspace. It is envisioned that stratospheric platforms may fly at altitudes between 60,000 and 100,000 feet from the surface of the earth. Thus, the stratospheric platforms are in a significantly lower position than even low earth orbit satellites.

The present invention may also be used for displaying various wireless communication signals on a personal mobile device 36 such as a laptop computer 38, a personal digital assistant 39, and a cellular telephone 40. It should be noted that these devices and the automotive-based devices may also receive wireless signals having various types of information associated therewith from the cellular towers 34A and 34B. Other types of information in a communication signal may be broadcast from other types of broadcasting areas such as an antenna 42 on a building 44. The building may, for example, generate location-specific signals therefrom. The building 44 may be various types of buildings such as a store and the wireless information transmitted from the antenna 42 may be advertising information. All of the wireless signals preferably include location-specific information transmitted therewith. As will be described below, the information may be coded digitally into the signals. Thus, by reviewing the location information, signals appropriate for the location of the mobile devices may be displayed on the various devices. This will be further described below.

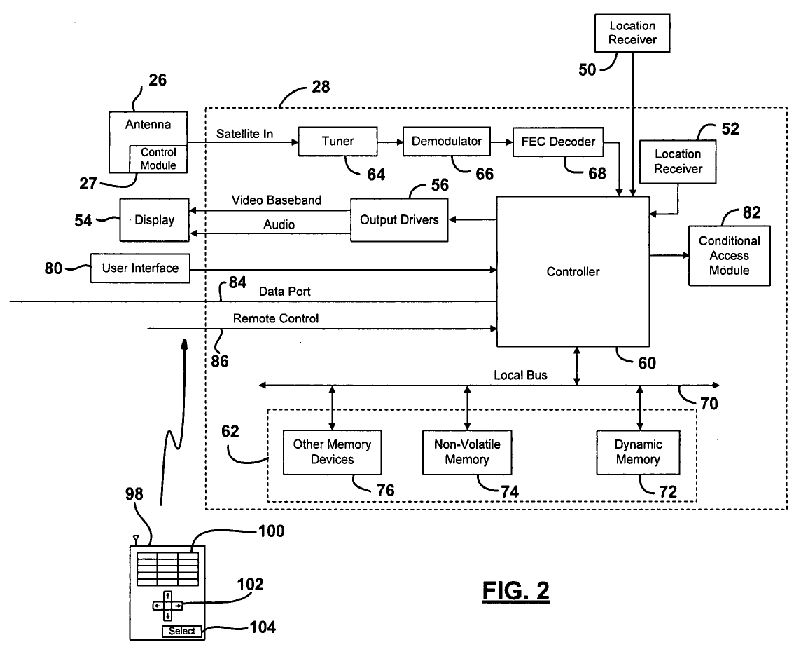

Referring now to FIG. 2, a receiving unit 22 is illustrated in further detail. Although the receiving unit 22 is illustrated, or is merely representative of various electronic devices with internal controllers. Antenna 26 may be various types of antennas including a rotating antenna which is used to track the relative movement of the satellite or other transponding device with respect to the vehicle. The antenna 26 may be a single antenna used for satellite television reception, or a number of antennas such as one for receiving television signals and one coupled to a location receiver 50 such as GPS receiver. The antenna 26 may also be an electronic antenna. The antenna 26 may include an internal controller 27 that controls the operation of the antenna 26.

The mobile receiver unit 28 is coupled to antenna 26 with a two-way communication channel such as a wire or a wireless system. The mobile receiving unit 28 may also include a location module or location receiver 52 integrated therein. The location receiver 52 may be a GPS receiver. In a preferred embodiment, only one location receiver 50, 52 may be provided in the system. However, the location receiver 50, 52 may be part of the vehicle 24 or may be part of the mobile receiving system 22, 36. The controller 60 may be coupled directly to location receiver 52 and/or location receiver 50.

The location receiver 52 is capable of providing latitude and longitude to the controller 60. The controller 60 may be used to compare the location signals from the location receiver 50, 52 to the boundaries of the areas of interest such that the mobile device can determine which areas of interest it is within and which areas of interest it is not within. From this determination it can control IRD behavior such as allowing or disallowing display of certain audio or video channels or advertising or the like. One application is to broadcast areas of interest that represent designated marketing areas to determine which designated marketing area the mobile device is within and which area it is not within, which signals the system should be receiving. These signals may coincide with or coordinate to the local broadcasting signals for the specific designated marketing area. It should be noted that more than one designated marketing area may be provided for a particular area. That is, adjacent areas may also be authorized for viewing. Various fringe regions may be used around a particular designated marketing area to provide hysteresis for the system. This function will be further described below.

The mobile receiving unit 28 includes a display 54. The display 54 may be incorporated into the device 36 or within the vehicle 24. The display 54 may include output drivers 56 used for generating the desired audio and video outputs suitable for the particular display 54.

A controller 60 may be a general processor such as a microprocessor. The controller 60 may be used to coordinate and control the various functions of the receiving unit 28. These functions may include a tuner 64, a demodulator 66, a forward error correction decoder 68 and any buffers and other functions. The tuner 64 receives the signal or data from the individual channel. The demodulator 66 demodulates the signal or data to form a demodulated signal or data. The decoder 68 decodes the demodulated signal to form decoded data or a decoded signal. The controller 60 may be similar to that found in current DirecTV set top boxes which employ a chip-based multifunctional controller.

The controller 60 may include or be coupled to a local bus 70. The local bus 70 may be used to couple a memory including dynamic memory 72 such as RAM which changes often and whose contents may be lost upon the interruption of power or boot up. The bus 70 may also be coupled to a non-volatile memory 74. The non-volatile memory may be an in-circuit programmable type memory. One example of a non-volatile memory is an EEPROM. One specific type of EEPROM is flash memory. Flash memory is suitable since it is sectored into blocks of data segments that may be individually erased and rewritten.

Memory 62 may be used to store the boundaries of various areas of interest received from the antenna as broadcast by one of the devices 32, 33 or 34 described above. An area of interest is a fixed geographic or cartographic area bounded by a closed shape such as a polygon, circle, curved or straight line segments, or the like. The fixed area or closed shape has outer boundaries that do not move on the surface of the earth. As will be shown below, areas may be excluded (island-like) within a closed shape. Although the areas are fixed, they may be, from time to time, redetermined and rebroadcast to the mobile device for usage. A key feature is that as the vehicle or mobile device moves, the area of interest remains fixed on the surface of the earth and thus the device may enter into another area of interest. Boundaries of certain areas of interest such as a designated marketing area (DMA) may be defined by Nielsen and may be pre-programmed into the memory 62 as a number of polygons wherein each point of each side is defined in cartographic coordinates of longitude and latitude and fractions of degrees. As will be described below the polygons may be formed of corners whose latitude and longitude are stored within the memory.

Other memory devices 76 may also be coupled to local bus 70. The other memory devices may include other types of dynamic memory, non-volatile memory, or may include such devices such as a digital video recorder. The display 54 may be changed under the control of controller 60 in response to the data in the dynamic memory 72 or non-volatile memory 74.

The controller 60 may also be coupled to a user interface 80. User interface 80 may be various types of user interfaces such as a keyboard, push buttons, a touch screen, a voice activated interface, or the like. User interface 80 may be used to select a channel, select various information, change the volume, change the display appearance, or other functions. The user interface 64 is illustrated as part of the mobile receiving unit. However, should the unit be incorporated into a vehicle, the user interface 80 may be located external to the mobile receiving unit such as dial buttons, voice activated system, or the like incorporated into the vehicle and interface with the mobile receiving unit.

A conditional access module card 82 (CAM) may also be incorporated into the mobile receiving unit. Access cards such as a conditional access module (CAM) cards are typically found in DirecTV units. The access card 82 may provide conditional access to various channels and wireless signals generated by the system. Not having an access card or not having an up-to-date access card 66 may prevent the user from receiving or displaying various wireless content from the system.

One user interface is a remote control device 98 having a key pad 100, an arrow key pad 102, and a select button 104 may also be provided. Inputs to the receiver 28 may be provided by the remote control device 28 or through another type of user interface 80.

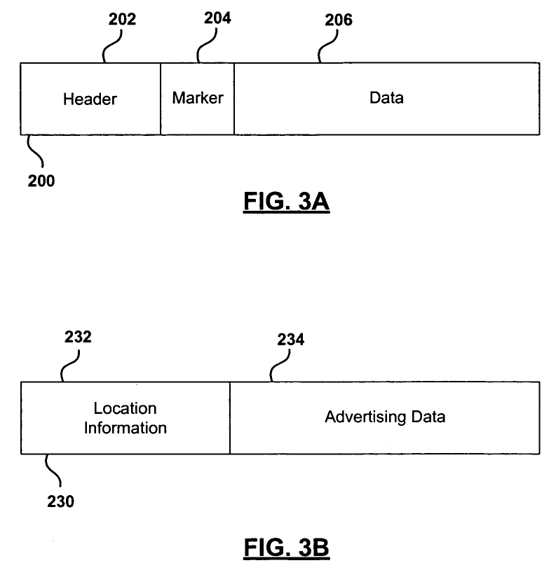

Referring now to FIG. 3A, a communication signal 200 may include various information therewith including a header 202, an identifier or marker 204, and data 206. As can be seen, the communication signal 200 may be a digital signal. The header 202 may include various information and may also include the marker 204 therein. The marker 204 may also be a separate segment. The identifier or marker 204 may be used to identify a segment of advertising. The identifier or marker 204 may include various types of codes, series of codes, or other identifying information.

The data 206 may be various types of audio signals, video signals, data signals, or the like. In one preferred embodiment, the data 206 may correspond to satellite signals received from a satellite or other high-altitude communication device.

Referring now to FIG. 3B, an advertising signal 230 includes location information 232 and advertising data 234. The location information 232 may include a geographic vocation or range of locations for which the information is valid.

The advertising data 234 may include various types of audio signals, video signals, data, or the like.

As will be described below, the advertising data 234 may be displayed in place of other general advertising based upon the location of the receiving device in response to the location information 232.

The advertising signal 230 may also append a set of instructions to be evaluated by the mobile receiving device such that behavior can be controlled as a result of the evaluation. An example instruction is to state that this advertisement should only be displayed if the user is located within a certain geographic area described in location information 232 and if the user is tuned to a sports channel. The sports channel category could be a code associated with the communication signal 200.

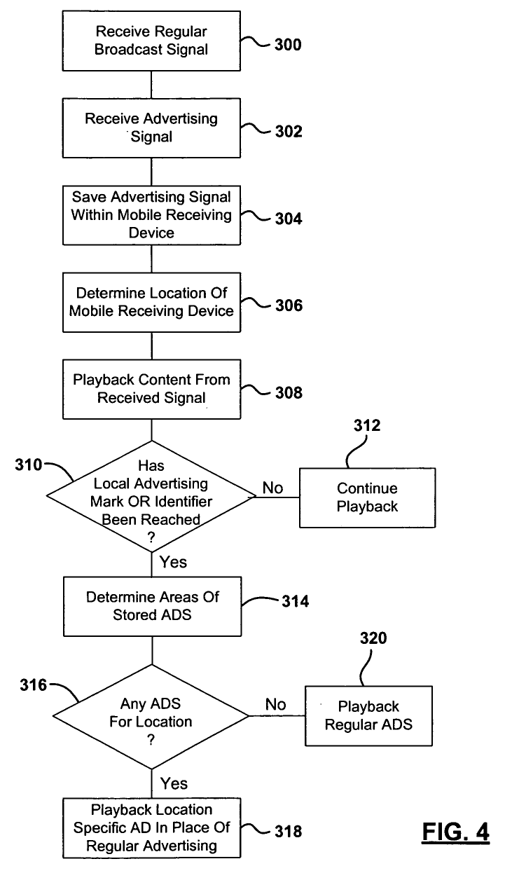

Referring now to FIG. 4, a method of operating a mobile receiving device is set forth. In step 300, regular broadcast signals are received at a receiver. The receiver may be a mobile receiver that receives information from various types of devices including a high-altitude device, which may include a stratospheric platform or a satellite, or terrestrial based systems which use ATSC broadcast towers.

In step 302, advertising signal 230 is received. The advertising signal may be generated from various sources including terrestrial-based sources such as a cell tower or an antenna on a building, or from a high-altitude communication device such as a satellite or stratospheric platform.

In step 304, the advertising signal may be saved within the mobile receiving device for eventual playback.

In step 306, the location of the mobile receiving device is determined from a location device such as a global positioning system or by triangulation from cellular towers, or the like.

In step 308, content is played back from the received signal.

In step 310, the signal is monitored to determine if a local advertising mark or identifier has been reached. If no mark or identifier has been reached, step 312 continues to play back the content.

In step 310, if a local mark or identifier has been reached, step 314 is performed. In step 314, the location information received with the advertising signal is used to determine the area suitable for the stored ads. Also if the mark contains other codes or instructions it can be evaluated at this point in addition to the location information to determine which local ads should be displayed.

In step 316, if any ads stored in the system correspond to the location of the mobile receiving device, step 318 is performed. In step 318, the display is changed to display the location-specific ad (or other real-time information) in place of the regular advertising or real-time information. Optionally if extra instructions or codes are placed with the ad it can be evaluated at this point to determine if that particular ad should be displayed.

In step 316, if no ads for the specific location are available, the regularly broadcast ad or real-time information is displayed in step 320.

Although the embodiment set forth above is for advertising, various real time content may also be provided in place of advertising.

While particular embodiments of the invention have been shown and described, numerous variations and alternate embodiments will occur to those skilled in the art. Accordingly, it is intended that the invention be limited only in terms of the appended claims.

What is claimed is:

1. A method of operating a mobile broadcasting system comprising:
determining a location of a mobile receiving device;
broadcasting a communication signal having a marker therein;
broadcasting location-specific content to a mobile receiving device;
generating a display with a mobile receiver corresponding to the communication signal until the marker; and
changing the display with the mobile receiver to display the location-specific content in response to the marker and the location.

2. A method as recited in claim 1 wherein broadcasting location-specific content comprises broadcasting location-specific information from a terrestrial source.

3. A method as recited in claim 2 wherein the terrestrial source comprises a cell tower.

4. A method as recited in claim 1 wherein broadcasting location-specific content comprises broadcasting location specific information from a space-based source.

5. A method as recited in claim 4 wherein the space-based source comprises a satellite.

6. A method as recited in claim 1 wherein broadcasting location-specific content comprises broadcasting location-specific information from a stratospheric platform.

7. A method as recited in claim 1 wherein the mobile device comprises a mobile phone.

8. A method as recited in claim 1 wherein the mobile device comprises a personal electronic device.

9. A method as recited in claim 1 wherein the mobile device comprises a vehicle mounted receiving device.

10. A method as recited in claim 1 wherein determining a location comprises determining the location in response to a GPS receiver.

11. A method as recited in claim 1 wherein determining a location comprises determining the location in response to a GPS receiver disposed within an automotive vehicle.

12. A method as recited in claim 1 wherein determining a location comprises determining the location in response to a GPS receiver disposed within the mobile receiving device.

13. A method as recited in claim 1 wherein determining a location comprises determining the location in response to a cellular phone system.

14. A method as recited in claim 1 wherein the mobile receiving device comprises an integrated receiver decoder.

15. A method as recited in claim 1 wherein broadcasting a communication signal comprises broadcasting a video signal.

16. A method as recited in claim 1 wherein broadcasting a communication signal comprises broadcasting a satellite television signal.

17. A method as recited in claim 1 wherein broadcasting a communication signal comprises broadcasting a satellite signal from a satellite.

18. A method as recited in claim 1 wherein broadcasting a communication signal comprises broadcasting the communication signal from a stratospheric platform.

19. A method as recited in claim 1 wherein broadcasting location-specific content to a mobile receiving device comprises broadcasting location information and further comprising comparing the location information to the location, and wherein changing the display comprises changing the display when the location is within the location information.

20. A method of operating a mobile satellite receiver comprising:
determining a location of a mobile satellite receiver;
receiving a satellite signal having a marker therein;
receiving location-specific content and location information in a mobile satellite receiver;
displaying the satellite signal on a mobile satellite receiver until the marker;
comparing the location and an area defined by the location information; and
displaying the location specific content in response to the marker and when the location is within the area.

21. A method as recited in claim 20 wherein the mobile device comprises a mobile phone, a personal electronic device or a vehicle mounted receiving device.

22. A method as recited in claim 20 wherein the mobile receiving device comprises an integrated receiver decoder.

23. A method as recited in claim 20 further comprising storing the location-specific content in a memory of the mobile satellite receiver.

24. A system comprising:
a high altitude communication device;
a network operations center communicating uplink signals to the satellite;
said high altitude communication device broadcasting a satellite signal corresponding to the uplink signal to a receiver;
a second communication device generating location specific content;
a location module generating a location signal; and
a receiver coupled to the location module, said receiver receiving the satellite signal having a marker therein, receiving the location-specific content to a mobile receiving device, displaying the satellite signal on a mobile receiver until the marker, displaying the location specific content in response to the marker and the location signal.

25. A system as recited in claim 24 wherein the high altitude communication device comprises a satellite.

26. A system as recited in claim 24 wherein the high altitude communication device comprises a stratospheric platform.

27. A system as recited in claim 24 wherein the second communication device is the high altitude communication device.

28. A receiver comprising:
a location module generating a location signal; and
a controller receiving a satellite signal and determining the presence of a marker, said controller receiving location-specific content with location information, said controller controlling a display by displaying the satellite signal until the marker, then displaying the location specific content in response to the marker and the location signal.

29. A receiver as recited in claim 28 said controller determining if the location signal is within an area defined by the location information.
